(19) United States
(12) Patent Application Publication
(10) Pub. No.: US 2001/0050678 A1
(43) Pub. Date: Dec. 13, 2001

(54) Line electrode driving apparatus and image display apparatus having same

(76) Inventors: Keishi Nishikubo, Taki-gun (JP); Takafumi Kawaguchi, Taki-gun (JP)

Correspondence Address: Dike, Bronstein, Roberts & Cushman LLP, 130 Water Street, Boston, MA, 02109, US

(21) Appl. No.: 09/799,928

(22) Filed: Mar. 5, 2001

(30) Foreign Application Priority Data
Mar. 31, 2000 (JP) 2000-098448

(51) Int. Cl. G09G 3/36

(52) U.S. Cl. 345/204

(57) ABSTRACT

A line electrode driving apparatus of an image display apparatus of the present invention in which a start pulse is supplied to the second resigter corresponding to the first output terminal of a gate line, not to the first register of an output terminal corresponding to a dummy line that is provided on a side portion. Gate signals are consecutively outputted from the second through the 257-th output terminal, thereafter a gate signal is outputted from the first output terminal. With the arrangement, in a gate driver of a liquid crystal display apparatus of TFT active matrix type, in the case where the first gate line should be driven upon receipt of a trigger signal as in an ENAB mode, it is possible to drive the dummy line provided for compensating a difference in a voltage to be applied due to a difference of the parasitic capacitance between a pixel electrode and the gate line, without specified processing such as delaying processing with respect to an image data as well as without affecting other signal gate line due to simultaneous driving.

### FIELD OF THE INVENTION

The present invention relates to a line electrode driving apparatus suitably adapted as a gate driver of a liquid crystal display apparatus of TFT active matrix type and an image display apparatus having such a line electrode driving apparatus.

### BACKGROUND OF THE INVENTION

FIG. 6 is a front view that shows a single pixel region in a liquid crystal display apparatus of TFT active matrix type. A pixel of the n-th column and the n-th row is focused on in FIG. 6 . The following deals with such a focused pixel. On a transparent substrate, provided are to be right angles a plurality of gate lines . . . , Gn, Gn+1, . . . (when referring to the whole gate lines, hereinbelow merely referred to as a reference symbol G) and source lines . . . , Sn, Sn+1, . . . (when referring to the whole source lines, hereinbelow merely referred to as a reference symbol S). In the region separated by the lines G and S, a pixel electrode 1 is formed. The pixel electrode 1 is connected with a drain electrode 3 of a TFT (Thin Film Transistor) 2. A source electrode 4 of the TFT 2 is connected with a source line Sn of the n-th row and a gate electrode 5 is connected with a gate line Gn of the n-th column.

In the liquid crystal display apparatus in which each pixel is provided in the foregoing manner, when focusing on the relation between the gate lines G and the pixel electrode 1, the structure of FIG. 6 is a liquid crystal display apparatus of so-called a lower gate structure type. The lower gate structure type indicates that the gate line Gn of the n-th column is located on the lower side of the pixel electrode 1 of the n-th column in FIG. 6. Is formed a parasitic capacitance Cgd1 between the pixel electrode 1 and the gate line Gn. Also formed is a parasitic capacitance Cgd2 between the pixel electrode 1 and the gate line Gn−1. Note that when considering a pixel of the first column, a gate line G0 corresponding to the gate line Gn−1 in the pixel of the n-th column is not provided, thereby resulting in that the parasitic capacitance Cgd2 is not formed.

In contrast, as shown in FIG. 7, a drain level of the TFT 2 varies depending on a gate signal having an amplitude of v_{GP-P}. More specifically, through the parasitic capacitance Cgd2 a gate signal of the gate line Gn−1 causes the drain level of the TFT2 to change by ΔV2. Through the parasitic capacitance Cgd1 a gate signal of the gate line Gn causes the drain level of the TFT2 to change by ΔV1.

Here, assumed that C_{LC} is indicative of the capacitance of the pixel section and Cs is indicative of the auxiliary capacitance, the ΔV1 and ΔV2 are expressed as follows, respectively.

ΔV2=v_{GP-P}×{Cgd2/(C_{LC}+Cs+Cgd1+Cgd2)}

ΔV1=v_{GP-P}×{Cgd1/(C_{LC}+Cs+Cgd1+Cgd2)}

The ΔV1 induced by a gate signal of its own stage gate line Gn causes a center Vcom of the amplitude of the drain level of the TFT 2 to be lower by ΔV1 from a center Vsc of amplitude of the source signal. The ΔV2 induced by a gate signal of the previous stage gate line Gn−1 causes the root mean square value of a voltage applied to the liquid crystal to increase.

As has been discussed above, in the pixel of the first column, the gate line G0 of the previous stage that forms the parasitic capacitance Cgd2 does not exist. Accordingly, the above-mentioned ΔV2 is not generated, thereby resulting in that only in the pixel of the first column, the root mean square value of a voltage applied to the liquid crystal becomes lowered. Such a discrepancy in the difference of the root mean square value causes a problem. More specifically, when becoming worse drive conditions of the display apparatus such as the case where the ΔV2 is great or the case where the ambient temperature is high or low, the problem arises that the brightness of only the pixel of the first column looks different from that other pixels. For example, in the case of normally white type liquid crystal, the first line brightens so as to look like a brightening line.

In view of the foregoing circumstances, a conventional technique has been proposed in order to solve the problem as disclosed in, for example, Japanese unexamined patent publication No. 9-288260 (published on Nov. 4, 1997). The conventional technique is shown in FIG. 8. The same reference numerals are assigned to the members which have the same functions as those previously described, and the description thereof is omitted here. According to the conventional technique, in a panel of a lower gate structure type, a dummy line G0 is provided outside an effective display area so as to compensate the asymmetry, occurred between the pixel of the first column and the remaining pixels described above, in the vicinity of the pixel of the first column. With the arrangement, the parasitic capacitance Cgd2 is formed with respect to the pixel of the first column, thereby ensuring that the affecting amount of ΔV becomes equal to that of the second column and the following columns. Thus, the problem concerning the brightening line is solved.

In conformity with the foregoing conventional technique, according to another conventional technique disclosed in Japanese unexamined patent publication No. 8-43793 (published on Feb. 16, 1996), in a gate driver 10, the above-mentioned gate lines G1 through Gm are driven by the gate signals from the respective output terminals og1 through ogm, and the dummy line G0, further provided, is parallely connected with the gate line Gm of the last m-th column and is driven at a time.

Namely, according to the conventional technique disclosed in Japanese unexamined patent publication No. 8-43793, in the case of Cs-On-Gate, overcome is the deficiency such as the foregoing brightening line by driving the gate line connected to Cs of the last column. In such a case, the gate line G0 of the first column and the gate line Gm of the last column are connected with each other and are driven, thereby ensuring that the avoiding of the brightening line is made without any addition of the specified circuit.

According to the conventional technique, however, a single gate output should drive two gate bus lines. Thus, only a driver circuit, of the output terminal ogm for driving the gate line Gm of the last m-th column, burdens a load of almost twice, thereby arising the problem that the waveform of the gate signal is blunt and so on Further, it is necessary to prepare a bus line for connecting the dummy gate line G0 and the gate line Gm. This causes the problem that the structures of the panel and the flexible print board substrate become complicated.

In order to overcome the problem, there has been proposed a gate driver 10a in which the number of output terminals is increased so as to drive individually the dummy gate line G0.

FIGS. 10 and 11 are wave form drawings respective showing a currently well used line electrode driving method in a liquid crystal display apparatus of TFT active matrix type. In FIGS. 10 and 11, the liquid crystal display apparatus is presumed to be so-called an XGA panel having 1024×768 dots.

FIG. 10 ia a diagram showing wave forms that explain a method called as the HV mode. In the HV mode, a display position in a horizontal direction is set in accordance with a horizontal synchronization signal US. In FIG. 10, a display data D1 is inputted upon receipt of the 296-th clock signal CK since the horizontal synchronization signal HS became active (low level). At this timing, an enable signal ENAB becomes active so that the source driver starts to read data signals D1, D2, . . . , D1024. Upon receipt of a latch signal LS (not shown), the source driver outputs in parallel at a time a display data voltage corresponding to the data signals D1, D2, . . . , D1024 through all the output terminals as data voltage DHn for one line.

Thus, output data is delayed by one horizontal period with respect to the input data of the source driver. Note that input data DHn is drawn in the wave form of the enable signal ENAB, while output data DHn is drawn in the wave form of DATA, in FIG. 10, for convenience sake.

In contrast, a display position in a vertical direction is set in accordance with a vertical synchronization signal VS. In FIG. 10, a data signal DH1 of the first column is inputted upon receipt of the 35-th clock signal CK since the vertical synchronization signal VS became active (hereinbelow referred to as merely 35H).

Accordingly, in the display panel having the foregoing dummy gate line G0, an accurate start position of the display position in a vertical direction is at 34H as shown in FIG. 10. More specifically, after inputting the start pulse sp to the gate driver 10a and driving the dummy gate line GO by the driver circuit associated with (relating to) the output terminal og1, at the timing in which the data signal DH1 is outputted, the driver associated with the output terminal og2 drives the gate line (the first gate line) G1 first of all.

As has been discussed above, when there is a time margin during the period between the activeness of the vertical synchronization signal VS and the starting of inputting of the first data, it is easy to drive the display panel having the dummy gate line G0 by use of the conventional gate driver in which consecutive outputting is carried out from the output terminal og1 upon receipt of the start pulse sp.

In contrast, according to a driving method called as recently prevailing ENAB mode, the display positions in the vertical and horizontal directions are determined by use of only effective region designation signal ENAB that has both elements of the vertical synchronization signal and the horizontal synchronization signal. Accordingly, the conventional gate driver can not drive the display panel having the dummy gate line G0. FIG. 11 shows the fact.

In the ENAB mode, the operation for determining the display position in the horizontal direction, i.e., for fetching and outputting the horizontal data is the same as that of the HV mode, but constitutes a difference in a timing for determining the display position in the vertical direction. Ac cording to the ENAB mode, when the period during which the effective region designation signal ENAB is non-active has continued for a specified period (in the case of FIG. 11, the specified period is 2H), such a period is regarded as a vertical blanking period and the display start position in the vertical direction is determined in accordance with the timing in which the effective region designation signal ENAB becomes active again.

Therefore, in the case where the display start position in the vertical direction is determined in accordance with a timing in which the effective region designation signal ENAB becomes active and the start pulse sp is immediately outputted, it is most likely that the timing of the outputting of the data signal DH1 is coincident with that of the driver circuit associated with the output terminal og1. When driving the display panel in which the dummy gate line G0 is not provided, the gate signal from the output terminal og1 drives the first gate line G1, thereby causing no problem. In contrast, when driving the display panel in which the dummy gate line GO is provided, the gate signal from the output terminal og1 drives the gate line G0 first, thereby causing that the data signal DH1 is not displayed. Namely, the start pulse sp and the gate signal from the output terminal og1 must be outputted in accordance with the timing shown in a broken line of FIG. 11. However, such outputtings are not possible.

When trying to consecutively output each gate signal to the dummy gate lines G0, and the gate lines G1, . . . , G768, it is necessary to respectively delay by one line the data signal DH1, DH2, . . . , DH768 of the respective lines, thereby causing the complexity of the circuit arrangement. The similar problem arises in the case where so called an upper gate structure type in which the dummy gate line Gm+1 is provided and the dummy gate line Gm+1, the gate lines Gm, Gm−1, . . . , G2, G1 are consecutively scanned.

### SUMMARY OF THE INVENTION

It is an object of the present invention to provide a line electrode driving apparatus and an image display apparatus having same which carry out a line electrode driving with respect to a dummy line, without specified processing such as delaying processing with respect to an image data as well as without affecting other signal gate line.

In order to achieve the foregoing object, the line electrode driving apparatus of the present invention is characterized in that the driving of a dummy gate line disposed on a higher side than the first signal line or a gate line disposed on a lower side than the last signal line is carried out in accordance with an order that is different from an order in which the respective output terminals are disposed. For example, it is started to output a driving signal from the second output terminal corresponding to the first signal line and output a driving signal from the first output terminal corresponding to the dummy gate line which is disposed on a higher side last of all.

With the arrangement, in response to a signal such as a start pulse, it is possible immediately to drive from the first signal line so that the dummy gate line is driven during a period such as a vertical blanking period. Therefore, even in the case where the dummy gate line is disposed on a higher side of the first gate line, it is possible to realize a line electrode driving of the dummy gate line without a specified processing such as delaying processing with respect to an image data as well as without affecting other signal gate lines due to simultaneous driving with respect to the dummy line and the normal signal line.

It is preferable that the driving signals are consecutively outputted to the second through (N−1)-th output terminals, and thereafter the driving signal is outputted at a time to the first and N-th output terminals, respectively, last of all.

With the arrangement, in the case where the dummy gate line is provided on the first gate line side of the effective display area as well as in the case where the dummy gate line is provided on the last gate line side of the effective display area, it is possible to use a common line electrode driving apparatus.

Another line electrode driving apparatus of the present invention, in order to achieve the object, when driving the line electrodes by dividing into a plurality of line electrode driving apparatuses, the respective line electrode driving apparatuses are connected in series with each other, and a previous stage line electrode driving apparatus outputs a driving signal through the last output terminal while transmits a scanning start signal to the following stage line electrode driving apparatus.

With the arrangement, even when using a plurality of line electrode driving apparatuses so as to drive the dummy line, it is possible to consecutively drive the line electrodes.

In order to achieve the object, a further line electrode driving apparatus of the present invention realized as for example a gate driver of a liquid display apparatus of TFT active matrix type, in which a dummy line is provided, outside an effective display area, for compensating an asymmetry such as parasitic capacitance between the pixel region in a periphery of the effective display area and the signal lines, is characterized in that , in response to a scanning start signal, outputs are consecutively supplied to the first and its following signal lines while suppiled to the dummy line last of all.

Accordingly, when the outputs are consecutively made to the first and its following signal lines upon receipt of a scanning start signal such as a start pulse, the data to be displayed by each pixel, while the dummy line is driven during such as a period corresponding to a vertical blanking period. Therefore, when the dummy line is provided on the higher side of the first signal line, it is possible to realize a line electrode driving of the dummy line without a specified processing such as delaying processing with respect to an image data as well as without affecting other signal lines due to the driving with respect to the dummy line and the normal signal line at a time.

It is preferable that output terminals corresponding to the dummy line are provided on both outsides of output terminals that are consecutively disposed in correspondence with the respective first through the last signal lines, and the output is supplied at a time to the output terminals.

With the arrangement, in the case where the dummy line is provided on the first signal line side of the effective display area as well as in the case where the dummy gate line is provided on the last gate line side of the effective display area, it is possible to use a common line electrode driving apparatus.

The line electrode driving apparatus may be arranged so that the output terminals corresponding to the dummy line are provided so as to be on the side of the first signal line and on the side of the last signal line, respectively, and the output terminal on the side of the first signal line and the output terminal on the side of the last signal line form a pair to be driven.

With the arrangement, even in the case where, like so-called a Cs-on-Gate structure of the liquid crystal display apparatus of TFT active matrix type, either on the side of the first signal line or on the side of the last signal line, the pixel electrodes are also formed outside the effective display area, and dummy lines including the dummy line adjoining to the pixel electrode are plurally provided, it is possible to consecutively drive these dummy lines after driving the last signal line. With the arrangement, in the case where the dummy lines are provided on the first signal line side or on the last signal line, it is possible to use a common line electrode driving apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. The present invention will become more fully understood from the detailed description given hereinbelow and the accompanying drawings which are given by way of illustration only, and thus, are not limitative of the present invention.

### BRIEF DESCRIPTION OF THE DRAWINGS

FIG. 1 is a schematic explanatory diagram showing a structure of a liquid crystal display apparatus in accordance with the present invention.

FIG. 2 is a block diagram showing one example of a gate driver of the liquid crystal display apparatus shown in FIG. 1.

FIG. 3 is a wave form diagram explaining how a gate driver in accordance with the present invention operates the liquid crystal display apparatus shown in FIG. 1.

FIG. 4 is a schematic explanatory diagram showing a structure of another liquid crystal display apparatus in accordance with the present invention.

FIG. 5 is a wave form diagram explaining how another gate driver in accordance with the present invention operates the liquid crystal display apparatus shown in FIG. 1.

FIG. 6 is a front view showing a single pixel region in a liquid crystal display apparatus of TFT active matrix type.

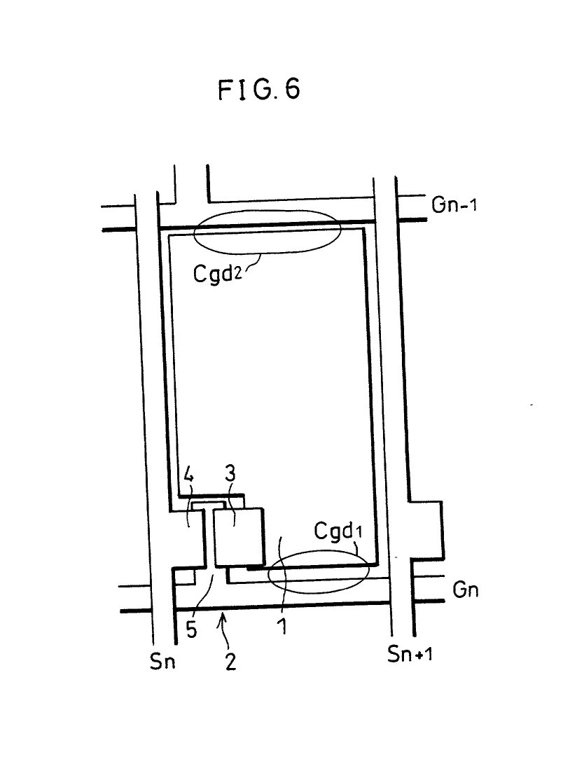

FIG. 7 is a wave form diagram showing a line electrode driving wave form of the liquid crystal display apparatus of FIG. 6.

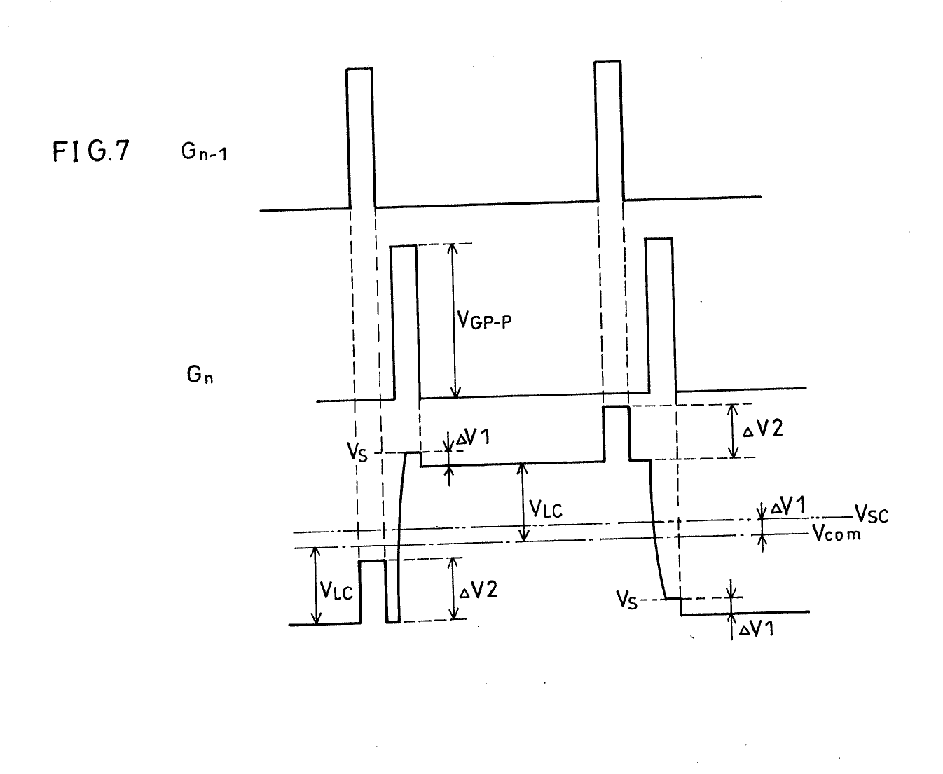

FIG. 8 is a schematic explanatory diagram showing a structure of a typical conventional liquid crystal display apparatus.

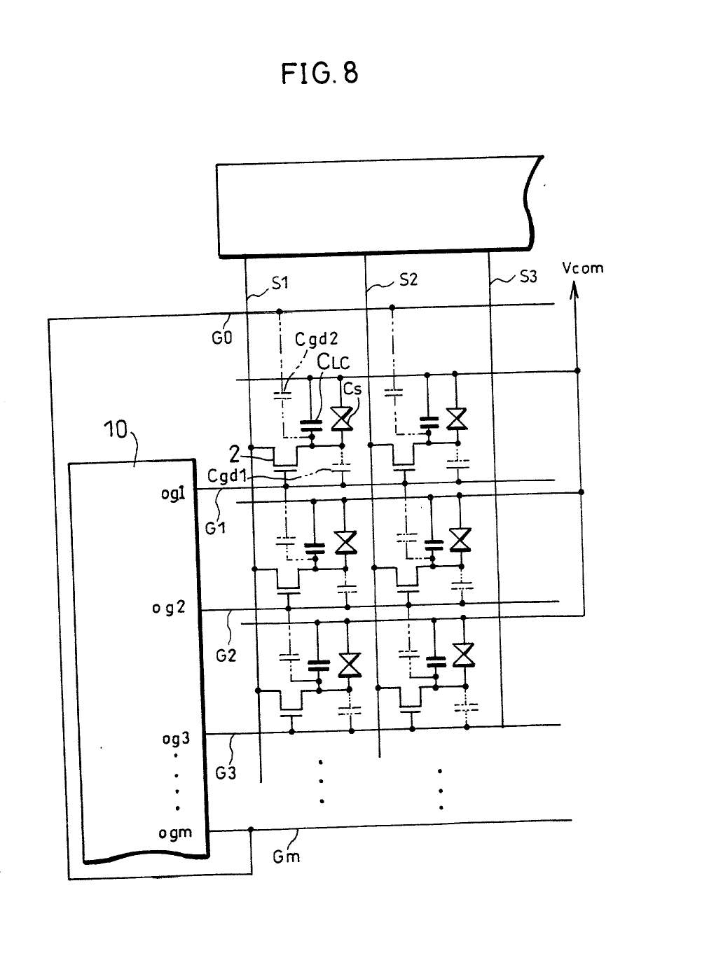

FIG. 9 is a schematic explanatory diagram showing a structure of another conventional liquid crystal display apparatus.

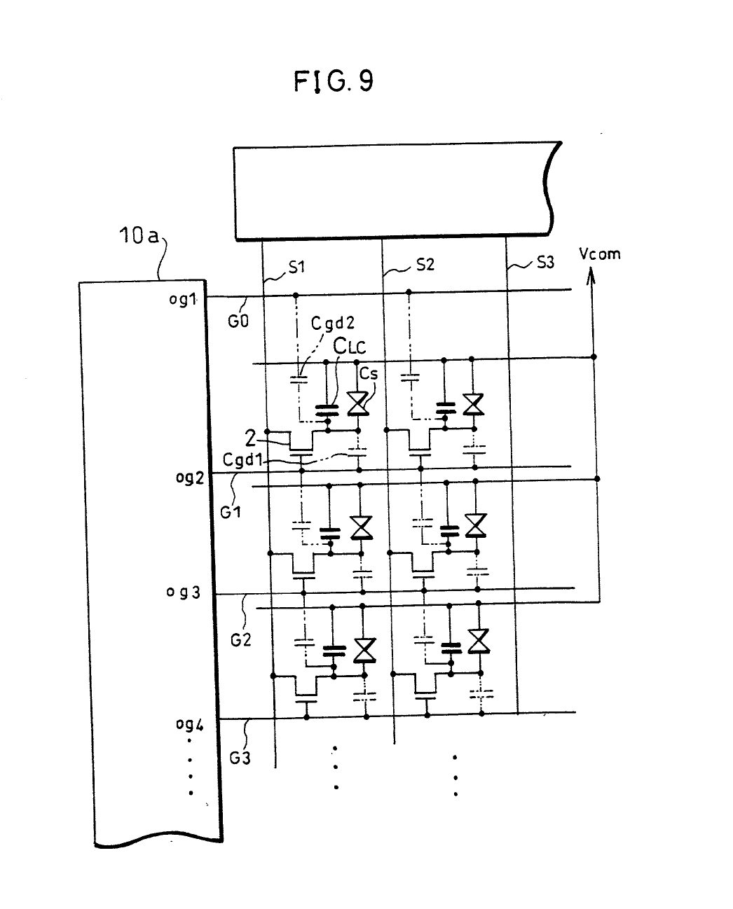

FIG. 10 is a wave form diagram explaining how the operation is made in an HV mode that is a prevailing line electrode driving method in a liquid crystal display apparatus of TFT active matrix type.

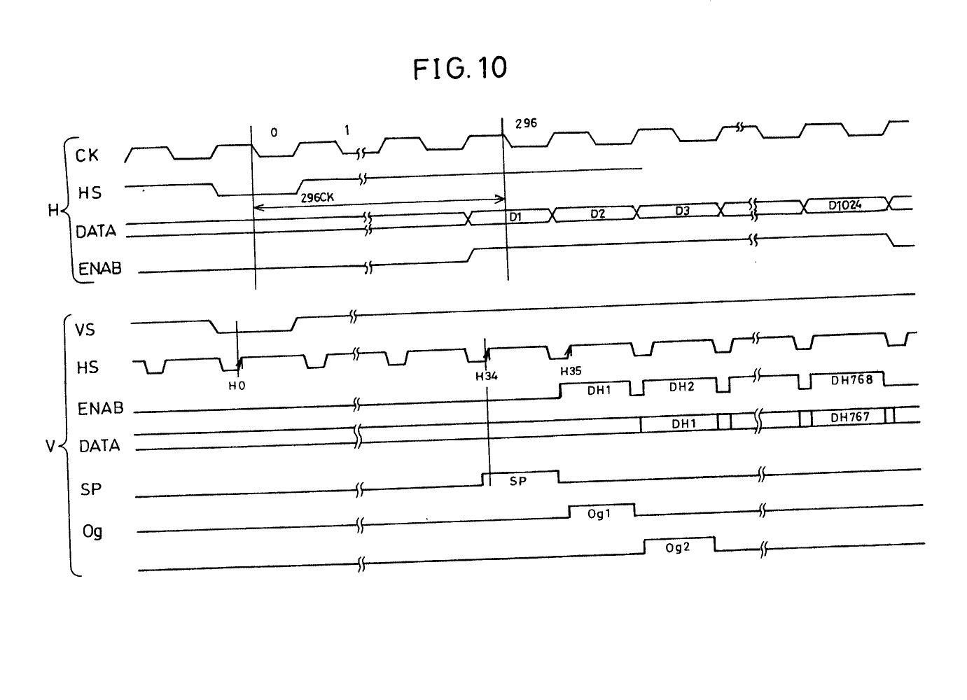

FIG. 11 is a wave form diagram explaining how the operation is made in an ENAB mode that is a prevailing line electrode driving method in a liquid crystal display apparatus of TFT active matrix type.

### DESCRIPTION OF THE EMBODIMENTS

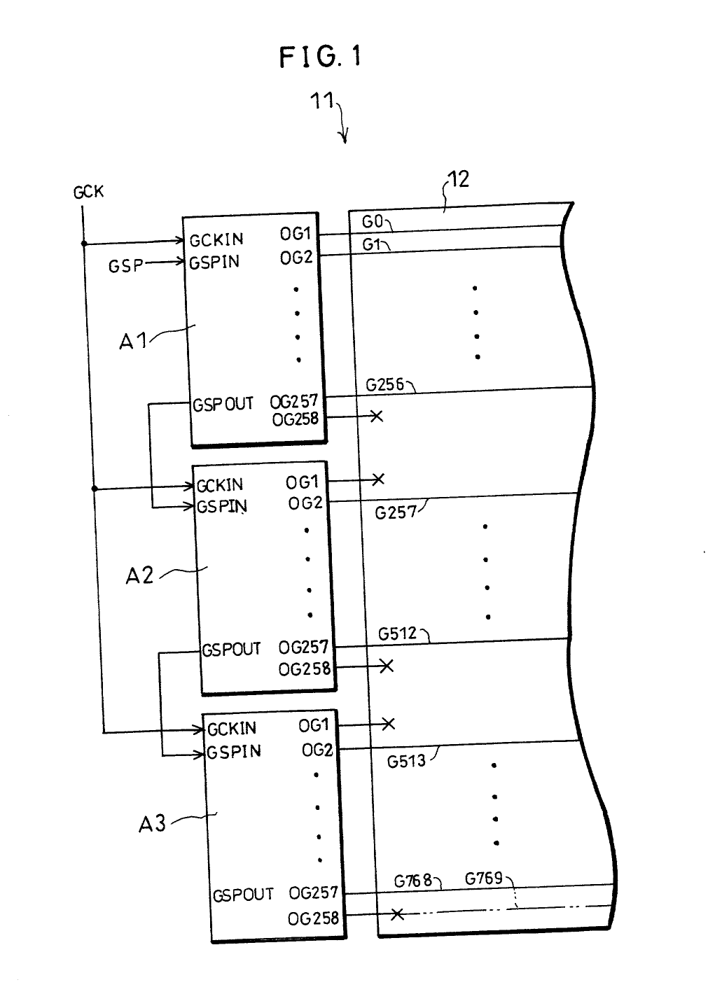

The following description deals with one embodiment of the present invention with reference to FIGS. 1 through 3.

FIG. 1 is a schematic explanatory diagram showing a structure of a liquid crystal display apparatus 11 in accordance with the present invention. A panel 12 of the liquid crystal display apparatus 11 is of a TET active matrix type, so-called an XGA panel having 1024×768 dots, and of a lower gate structure type that has the same structure as the one that has been described before. Accordingly, in the panel 12, a dummy gate line G0, gate lines G1, . . . , G768 in this order from the upper side of the panel 12 as shown in FIG. 1.

In the liquid crystal display apparatus 11, three gate drivers A1, A2, and A3 (when referring to the whole gate lines, hereinbelow merely referred to as a reference symbol A) are provided. The respective gate drivers have the same structure in which output terminals OG1, OG2, . . . , OG258 for respective gate signals, an input terminal GCKIN for clock GCK, an input terminal GSPIN for a start pulse GSP, and an output terminal GSPOUT for cascading a start pulse GSP to a following gate driver (next stage gate driver).

Each input terminal GCKIN of the respective gate drivers A1 through A3 is commonly supplied with the clock GCK. The input terminal GSPIN of the first stage gate driver A1 is supplied with the start pulse GSP. The input terminal GSPIN of the second stage gate driver A2 is connected with the output terminal GSPOUT of the first stage gate driver A1. The input terminal GSPIN of the third stage gate driver A3 is connected with the output terminal GSPOUT of the second stage gate driver A2.

The output terminals OG2 through OG257 of the first stage gate driver Al are connected with the gate lines G1 through G256, respectively. The output terminal OG1 is connected with a dummy gate line G0. The output terminals OG2 through OG257 of the second stage gate driver A2 are connected with the gate lines G257 through G512, respectively. The output terminals OG2 through OG257 of the third stage gate driver A3 are connected with the gate lines G513 through G768, respectively. The output terminal OG258 of the first stage gate drivers A1, and the output terminals OG1 and OG258 of the respective second and third stage gate drivers A2 and A3 are connected with a pad on the panel 12, respectively, but there are no corresponding gate lines on the panel 12.

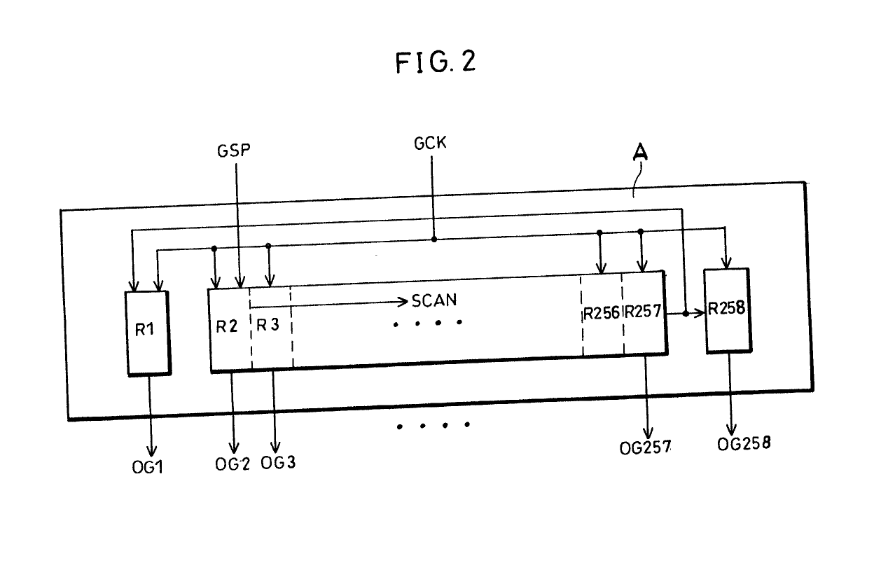

FIG. 2 is a block diagram showing one example of the gate driver A. In each gate driver A, disposed are 1-bit shift registers R1, R2 ,. . . , R257, R258 in this order. The outputs of the shift registers R1 through R258 are sent to the output terminals OG1 through OG258, respectively, through a level shifter and/or a buffer circuit (both not shown). In such a case, the gate signals are outputted from the shift registers having “1” output. The clock GCK is commonly supplied to the shift registers R1 through R258. Note that the start pulse GSP is supplied to the shift register R2 and that the output from the shift register R257 is supplied to the shift registers R1 and R257 in parallel.

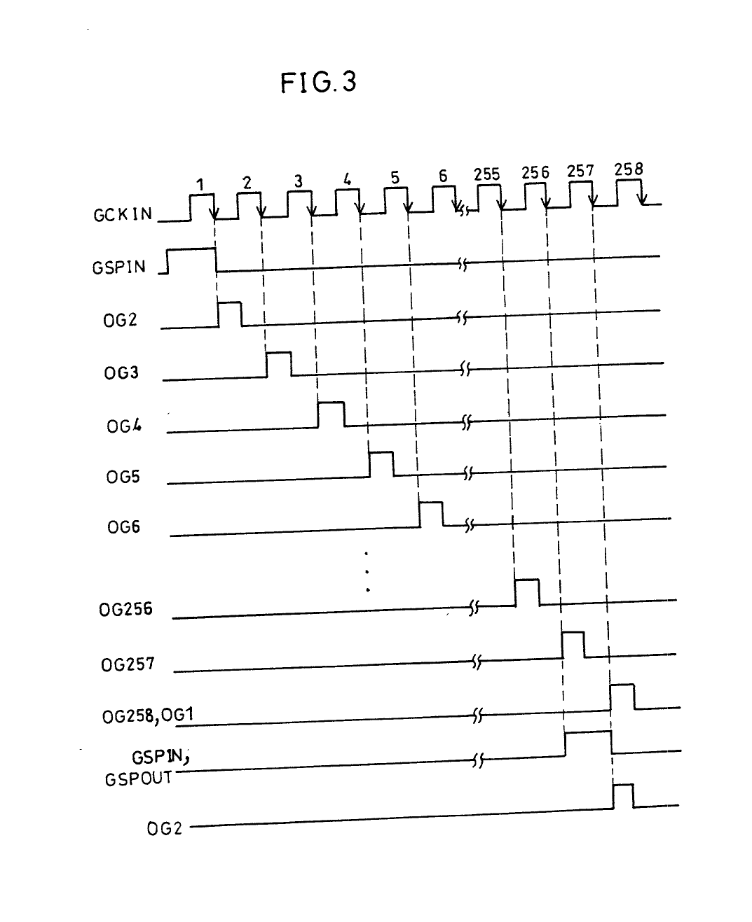

Accordingly, as to the gate driver A1, in response to the clock GCK inputted through the input terminal GCKIN and the start pulse GSP inputted through the input terminal GSPIN which are both generated by a timing control-use IC (not shown), as shown in FIG. 3, the respective gate signals are consecutively outputted through the output terminals OG2, OG3, OG4, . . . , OG257, OG258, and OG1, in accordance with the timing in which the clock GCK falls down after receiving the start pulse GSP.

On the way of the consecutive outputting of the gate signals, the gate driver A1 transmits the start pulse GSP to the next stage gate driver A2 through the output terminal GSPOUT, in accordance with a scanning start timing of the last gate line G256 in the effective display area to be driven by the gate driver A1. With the arrangement, when the gate driver A2 finishes the scanning of the gate line G256, the gate driver A2 continuously drives the gate line G257 upon receipt of the next clock GCK.

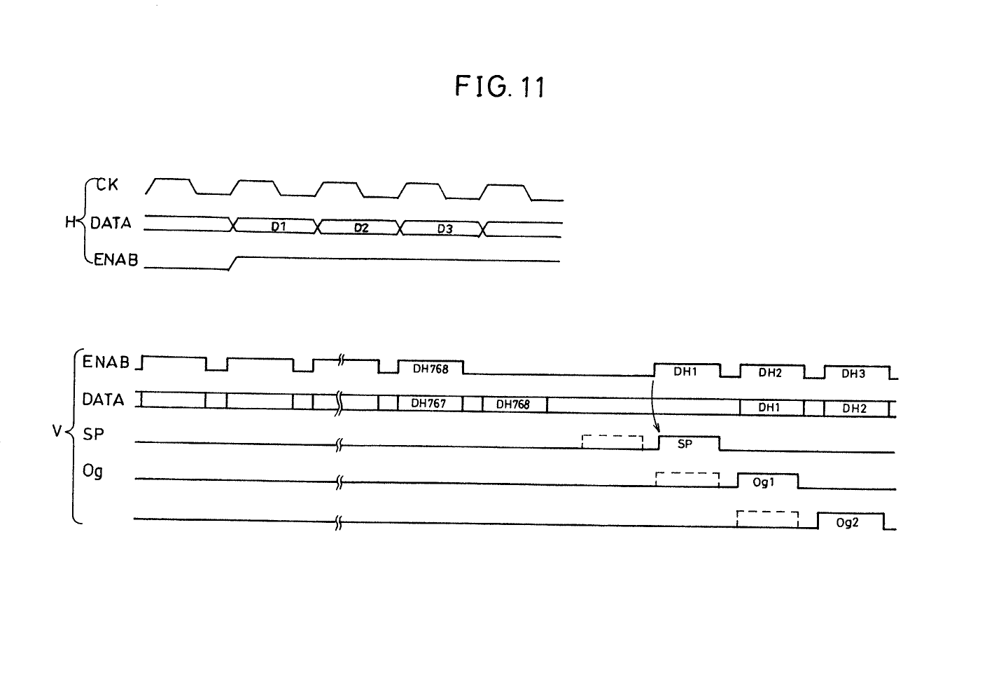

As has been discussed above, by driving the dummy gate line G0 last of all, even in the vertical direction V during the ENAB mode shown in FIG. 11, the data signal DR1, DH2, . . . , DH767, DH768 for the respective lines are consecutively fetched (read in). Accordingly, it is not necessary to care about the timing design, such as a specified processing (for example, delaying processing) with respect to an image data, for driving the dummy gate line G0. Further, it is not necessary to get another output signal (gate signal) of the gate driver A so as to drive the dummy gate line G0. This allows to simplify the peripheral circuits. Further, it is possible to carry out the line electrode driving of a dummy gate line.

When the scanning is consecutively carried out from the gate line 768, the start pulse GSP outputted from the timing control-use IC is supplied to the gate driver A3, thereafter is consecutively transmitted to the gate driver A2 and A1. For example, in the gate driver A1, the gate signals are consecutively outputted from the output terminals OG257, OG256, OG255, . . . , OG2, OG1, and OG258 , in this order. As shown in a two-dots-and-one-dashed line of FIG. 1, when the panel 12 is of an upper gate structure, the gate signal outputted from the output terminal OG258 of the gate driver A3 drives the dummy gate line G769 last of all.

Thus, the gate drivers A1 through A3 are respectively provided with the output terminals OG1 and OG258 for outputting the gate signal at a time. Accordingly, in the case where the dummy gate line is provided on the gate line G1 (the first gate line) side of the effective display area as well as in the case where the dummy gate line is provided on the gate line G768 (the last gate line) side of the effective display area, it is possible to use the common gate drivers A1 through A3. Such an arrangement allows to scan from the first gate line side or from the last gate line side. The output terminals OG1 and OG258 are driven at a time, but are individually provided with the output buffer. Further, as has been discussed, the gate line on the panel 12 actually corresponding to the output terminals OG1 and OG258 is provided only on one side of them, thereby avoiding the overload that was the problem of the conventional technique.

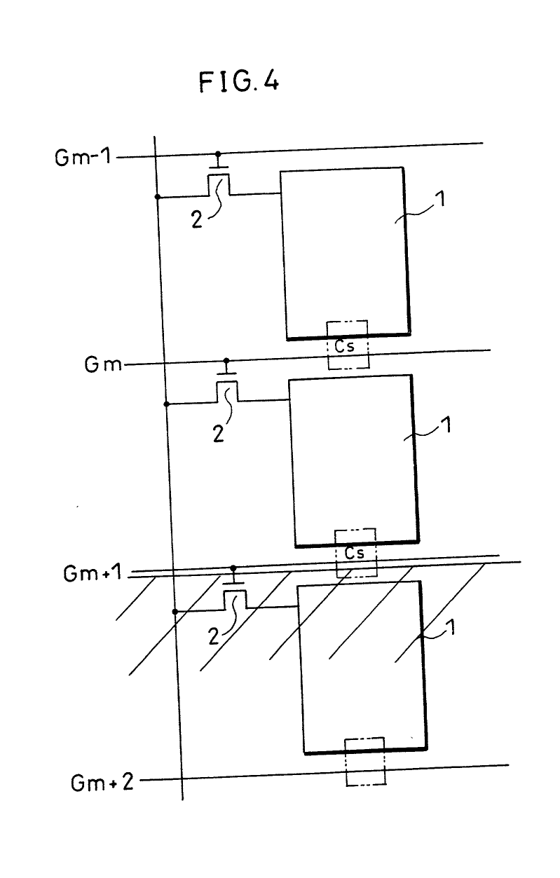

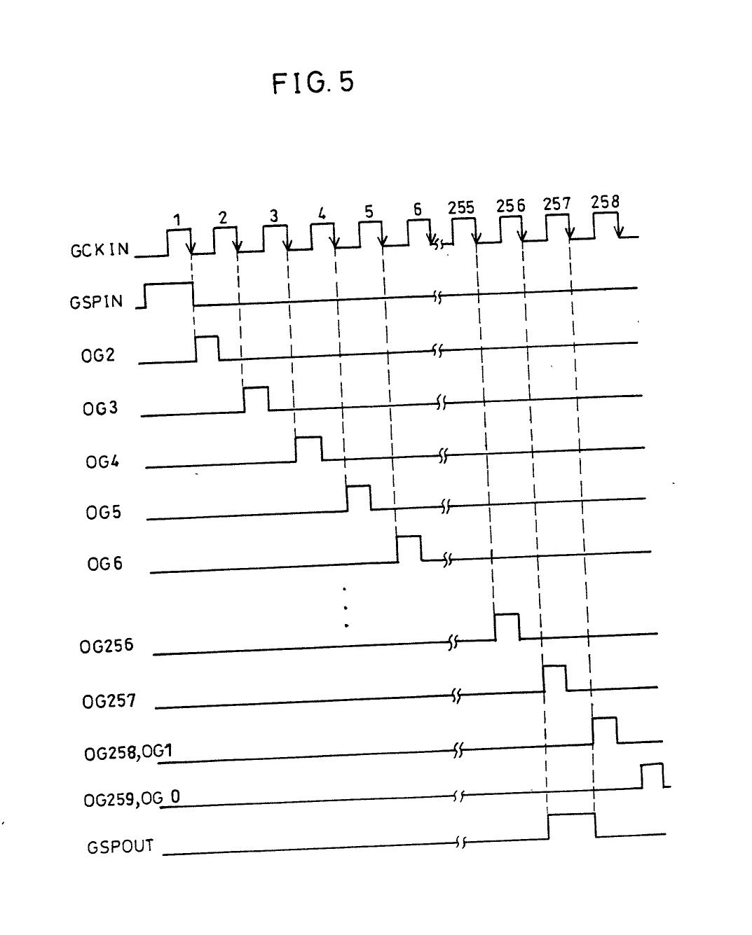

The following description deals with another embodiment in accordance with the present invention with reference to FIGS. 4 and 5.

FIG. 4 shows the structure of a panel 22 used in another embodiment of the present invention. The panel 22 is of the foregoing TFT active matrix type, and has so called a Cs-On-Gate structure. Further, the panel 22 is of an upper gate structure. Accordingly, the portion covered with black matrix that is marked by a hatched line is also provided with a pixel electrode 1, a TFT 2, and an auxiliary capacitance Cs so that the auxiliary capacitance Cs of the last gate line is equal to those of the remaining gate line. Thus, the total number of the dummy gate lines is two, i.e., Gm+1 and Gm+2.

A gate driver of the present embodiment in accordance with the present invention is arranged so that output terminals of OG1, OGO and OG258, OG259 are provided with outside output terminals OG2 and OG257, respectively. As shown in FIG. 5, after the gate signal is outputted from the output terminals OG1 and OG258, the gate signal is further outputted from the output terminals OGO and OG259.

Accordingly, in the case where a plurality of dummy gate lines are provided, the dummy gate lines can be consecutively driven. Further, in the case where the dummy gate line is provided on the gate line (the first gate line) G1 side of the effective display area as well as in the case where the dummy gate line is provided on the gate line (the last gate line) G768 side of the effective display area, it is possible to use the common gate drivers A1 through A3. Such an arrangement allows to scan from the first gate line side or from the last gate line side.

A line electrode driving apparatus for use in an image display apparatus in accordance with the present invention, as has been discussed, is provided with a plurality of output terminals that are consecutively disposed, in which, in response to a scanning start signal, driving signals for individually driving respective line electrodes of the image display apparatus are outputted in accordance with a clock signal period through the respective output terminals, wherein the driving signals are outputted in accordance with an order that is different from an order in which the output terminals are disposed.

With the arrangement, as mentioned above, in a line electrode driving apparatus of an image display apparatus which is realized as a gate driver of a liquid crystal display apparatus of TFT active matrix type or other apparatus, when driving such as a dummy line disposed on a higher side than the first signal line or a signal line disposed on a lower side than the last signal line, in accordance with an order that is different from an order in which the output terminals are disposed. For example, it is started to output a driving signal from the second output terminal corresponding to the first signal line (gate line) and output a driving signal from the first output terminal corresponding to the dummy line which is disposed on a higher side last of all.

Accordingly, in response to a scanning start signal such as a start pulse, it is possible immediately to drive from the first signal line (gate line), so that the dummy line is driven during a period such as a vertical blanking period. Therefore, even in the case where the dummy line is disposed on a higher side of the first signal line, it is possible to realize a line electrode driving of the dummy line without a specified processing such as delaying processing with respect to an image data as well as without affecting other signal lines due to such as a simultaneous driving.

Another line electrode driving apparatus in accordance with the present invention, as has been discussed, is provided with first through N-th output terminals that are consecutively disposed, in which, in response to a scanning start signal, driving signals for driving respective line electrodes of the image display apparatus are selectively outputted in accordance with a clock signal period through the respective output terminals, wherein, in response to the scanning start signal, the driving signals are consecutively outputted from the second output terminal to the N-th output terminal and the outputting of the driving signal to the first output terminal is carried out last of all.

Further, a line electrode driving apparatus of an image display apparatus in accordance with the present invention in which first through N-th output terminals are provided, and in response to a scanning start signal, driving signals, for driving line electrodes of the image display apparatus, are consecutively and selectively outputted to the first through N-th output terminals in accordance with a clock signal period, is characterized in that the driving signals are consecutively outputted to the second through (N−1)-th output terminals and thereafter the driving signal is outputted at a time to the first and N-th output terminals, respectively, last of all.

With the arrangement, in the case where the dummy line is provided on the first signal line side of the effective display area as well as in the case where the dummy line is provided on the last signal line side of the effective display area, it is possible to use a common line electrode driving apparatus.

Another line electrode driving apparatus of an image display apparatus in accordance with the present invention in which first through N-th output terminals are provided, and in response to a scanning start signal, driving signals, for driving respective line electrodes of the image display apparatus, are consecutively and selectively outputted to the first through N-th output terminals in a scanning direction or its reverse direction in accordance with a clock signal period, is characterized in that when the outputting is carried out in the scanning direction, the driving signals are consecutively outputted to the second through (N−1)-th output terminals and thereafter the driving signal is outputted to the first output terminal last of all, while when the outputting is carried out in the reverse direction, the driving signals are consecutively outputted to the (N−1)-th through first output terminals and thereafter the driving signal is outputted to the N-th output terminal last of all.

A further line electrode driving apparatus of an image display apparatus in accordance with the present invention in which first through N-th output terminals are provided, and in response to a scanning start signal, driving signals, for driving line electrodes of the image display apparatus, are consecutively and selectively outputted to the first through N-th output terminals in a scanning direction or its reverse direction in accordance with a clock signal period, is characterized irrespective of the scanning direction in that the driving signals are consecutively outputted in a designated scanning direction to the output terminals between the second and the (N−1)th output terminals and thereafter the driving signal is outputted at a time to the first and Nth output terminals last of all.

Still a further line electrode driving apparatus of an image display apparatus in accordance with the present invention in which a plurality of the foregoing line electrode driving apparatuses are connected in series and the scanning start signal is transmitted so that upon finishing of scanning by a driving signal outputted from a previous stage line electrode driving apparatus, a following stage line electrode driving apparatus starts to carry out scanning of a driving signal, is characterized in that in sychronization with the driving signal, which is supplied to the last output terminal, last of all, the scanning start signal is transmitted to the following line electrode driving apparatus.

With the arrangement, in response to a bulky image display apparatus, when driving the line electrodes by a plurality of line electrode driving apparatuses, these line electrode driving apparatuses are connected in series with each other, a previous stage line electrode driving apparatus outputs through the last output terminal a driving signal as well as transmits the scanning start signal to a following line electrode driving apparatus.

Accordingly, even when using a plurality of line electrode driving apparatuses so as to drive the dummy lines, it is possible to consecutively drive the line electrodes.

Another line electrode driving apparatus of an image display apparatus in accordance with the present invention in which two groups of signal lines, each group having a plurality of signal lines, that intersect with each other, a pixel formed by an intersecting region is driven by the intersecting signal lines, and a dummy line is provided, outside an effective display area, for compensating an asymmetry between the pixel region in a periphery of the effective display area and the signal lines, is characterized in that outputs are consecutively made to the first and its following signal lines and thereafter an output is made to the dummy line last of all.

With the arrangement, in a line electrode of an image display apparatus realized as, for example, a gate driver of a liquid crystal display apparatus of a TFT active matrix type, the signal lines are disposed on one side of the effective display area with respect to the pixel region, thereby resulting in that the peripheral section on the other side of the effective display area and the remaining section become asymmetrical. Such an asymmetry arises the problem that there occurs a difference in a voltage to be applied due to a difference of the parasitic capacitance between the pixel electrode and the gate line. In order to compensate such a difference, the dummy line is driven last of all.

Accordingly, when the outputs are consecutively made to the first and its following signal lines in response to a scanning start signal such as a start pulse, the data to be displayed by each pixel, while the dummy line is driven during such as a period corresponding to a vertical blanking period. Therefore, when the dummy line is provided on a higher side of the first signal line, it is possible to realize a line electrode driving of the dummy line without a specified processing such as delaying processing with respect to an image data as well as without affecting other signal lines such as a simultaneous driving.

Another line electrode driving apparatus of an image display apparatus in accordance with the present invention, is characterized in that output terminals corresponding to the dummy line are provided on both outsides of output terminals that are consecutively disposed in correspondence with the respective first through the last signal lines, and the output is supplied at a time to the output terminals.

With the arrangement, in the case where the dummy line is provided on the first gate line side of the effective display area as well as in the case where the dummy gate line is provided on the last gate line side of the effective display area, it is possible to use a common line electrode driving apparatus.

A further line electrode driving apparatus of an image display apparatus in accordance with the present invention, is characterized in that respective outputs corresponding to the dummy line are provided so as to be on the side of the first signal line and on the side of the last singal line, respectively, and the output terminal on the side of the first signal line and the output terminal on the side of the last signal line form a pair to be driven.

With the arrangement, even in the case where, like so-called a Cs-on-Gate structure of the liquid crystal display apparatus of TFT active matrix type, either on the side of the first signal line or on the side of the last signal line, the pixel electrodes are also formed outside the effective display area, and dummy lines including the dummy line adjoining to the pixel electrode are plurally provided, it is possible to consecutively drive these dummy lines after driving the last signal line. With the arrangement, in the case where the dummy lines are provided on the first signal line side or on the last signal line, it is possible to use a common line electrode driving apparatus.

There are described above novel features which the skilled man will appreciate give rise to advantages. These are each independent aspects of the invention to be covered by the present application, irrespective of whether or not they are included within the scope of the following claims.

What is claimed is:

1. A line electrode driving apparatus, provided with a plurality of output terminals that are consecutively disposed, in which, in response to a scanning start signal, driving signals for individually driving respective line electrodes of an image display apparatus are outputted in accordance with a clock signal period through the respective output terminals,
wherein the driving signals are outputted in accordance with an order that is different from an order in which the output terminals are disposed.

2. A line electrode driving apparatus in which first through N-th output terminals are provided, and in response to a scanning start signal, driving signals, for driving line electrodes of an image display apparatus, are consecutively and selectively outputted to the first through N-th output terminals in accordance with a clock signal period,
wherein the driving signals are consecutively outputted to the second through N-th output terminals while outputted to the first output terminal last of all.

3. A line electrode driving apparatus in which first through N-th output terminals are provided, and in response to a scanning start signal, driving signals, for driving line electrodes of an image display apparatus, are consecutively and selectively outputted to the first through N-th output terminals in accordance with a clock signal period,
wherein the driving signals are consecutively outputted to the second through (N−1)-th output terminals while outputted to the first and the N-th output terminals last of all.

4. A line electrode driving apparatus in which first through N-th output terminals are provided, and in response to a scanning start signal, driving signals, for driving respective line electrodes of an image display apparatus, are consecutively and selectively outputted to the first through N-th output terminals in a scanning direction or its reverse direction in accordance with a clock signal period,
wherein when the driving signals are outputted in the scanning direction, the driving signals are consecutively outputted to the second through (N−1)-th output terminals while outputted to the first output terminal last of all, and
when the driving signals are outputted in the reverse direction, the driving signals are consecutively outputted to the (N−1)-th through first output terminals while outputted to the N-th output terminal last of all.

5. A line electrode driving apparatus in which first through N-th output terminals are provided, and in response to a scanning start signal, driving signals, for driving line electrodes of an image display apparatus, are consecutively and selectively outputted to the first through N-th output terminals in a scanning direction or its reverse direction in accordance with a clock signal period,
wherein, irrespective of the scanning direction, the driving signals are consecutively outputted in a designated scanning direction to the output terminals between the second and the (N−1)th output terminals while outputted to the first and Nth output terminals last of all.

6. A line electrode driving apparatus in which two groups of signal lines, each group having a plurality of signal lines, that intersect with each other, a pixel formed by an intersecting region is driven by intersecting signal lines, and a dummy line is provided, outside an effective display area, for compensating an asymmetry between the pixel region in a periphery of the effective display area and the signal lines,
wherein, in response to a scanning start signal, outputs are consecutively supplied to the first and its following signal lines while supplied to the dummy line last of all.

7. The line electrode driving apparatus as set forth in claim 6, wherein output terminals corresponding to the dummy line are provided on both outsides of output terminals that are consecutively disposed in correspondence with the respective first through the last signal lines, and the output is supplied at a time to the output terminals.

8. The line electrode driving apparatus as set forth in claim 7, wherein the output terminals corresponding to the dummy line are provided so as to be on a side of the first signal line and on a side of the last signal line, respectively, and the output terminal on the side of the first signal line and the output terminal on the side of the last signal line form a pair to be driven.

9. A line electrode driving apparatus in which a plurality of the line electrode driving apparatuses as set forth in any one of claims 1 through 5 are connected in series and the scanning start signal is transmitted so that upon finishing of scanning by a driving signal outputted from a previous stage line electrode driving apparatus, a following stage line electrode driving apparatus starts to carry out scanning of a driving signal, wherein the scanning start signal is transmitted to the following line electrode driving apparatus in sychronization with the driving signal to be supplied to the last output terminal last of all.

10. An image display apparatus comprising the line electrode driving apparatus as set forth in any one of claims 1 through 8.

11. An image display apparatus comprising the line electrode driving apparatus as set forth in claim 9.

12. A line electrode driving apparatus in which, upon receipt of a scanning start signal, driving signals, for driving line electrodes of a plurality of signal lines and a dummy line, respectively, are outputted in synchronization with a clock signal,
wherein the line electrode of the dummy line is driven last of all.

13. The line electrode driving apparatus as set forth in claim 12,
wherein first through N-th shift registers, connected in series with each other, for outputting respective output signals as the driving respective signals, and
the scanning start signal is supplied to the second shift register, the output signal of the N-th shift register is supplied to the first shift register, and the output signal of the first shift register is outputted as the driving signal for driving the line electrode of the dummy line.

14. The line electrode driving apparatus as set forth in claim 12,
wherein first through N-th shift registers, connected in series with each other, for outputting respective output signals as the respective driving signals, and
the scanning start signal is supplied to the second shift register, the output signal of the (N−1)-th shift register is supplied to the first and the N-th shift registers, respectively.

15. A line electrode driving apparatus comprising a plurality of line electrode driving circuits connected in series with each other, in which each circuit is arranged so that, upon receipt of a scanning start signal, driving signals, for driving line electrodes of a plurality of signal lines and a dummy line, respectively, are outputted in synchronization with a clock signal, wherein the line electrode of the dummy line is driven last of all, the line electrode driving circuits consecutively driving the line electrodes.

16. An image display apparatus comprising the line electrode driving apparatus as set forth in any one of claims 12 through 15.
